(19) United States
(12) Patent Application Publication
(10) Pub. No.: US 2011/0227904 A1
(43) Pub. Date: Sep. 22, 2011

(54) ORGANIC LIGHT EMITTING DISPLAY AND METHOD OF DRIVING THE SAME

(76) Inventor: Sang-Moo Choi, Yongin-city (KR)

(21) Appl. No.: 12/949,766

(22) Filed: Nov. 18, 2010

(30) Foreign Application Priority Data
Mar. 17, 2010 (KR) 10-2010-0023764

(51) Int. Cl. G09G 5/00

(52) U.S. Cl. 345/212; 345/76

(57) ABSTRACT

An organic light emitting display has increased flexibility in controlling the voltage range of data signals. The organic light emitting display includes a scan driver for driving scan lines and emission control lines, a data driver for supplying data signals to data lines, pixels positioned at crossing regions of the scan lines and the data lines, first power source lines coupled to a first power source and the pixels, horizontal power source lines coupled to the pixels, a second power source line coupled to a second power source different from the first power source, and first switching elements respectively coupled between the horizontal power source lines and the second power source line. Each of the pixels stores a voltage corresponding to the second power source and the data signal and controls an amount of current that flows from the first power source to correspond to the stored voltage.

### CROSS-REFERENCE TO RELATED APPLICATION

This application claims priority to and the benefit of Korean Patent Application No. 10-2010-0023764, filed on Mar. 17, 2010, in the Korean Intellectual Property Office, the entire content of which is incorporated herein by reference.

### BACKGROUND

1. Field

Aspects of embodiments of the present invention relate to an organic light emitting display and a method of driving the same.

2. Description of Related Art

Various flat panel displays (FPDs) with reduced weight and volume in comparison to cathode ray tube (CRT) displays have been developed. The FPDs include a liquid crystal display (LCD), a field emission display (FED), a plasma display panel (PDP), and an organic light emitting display.

The organic light emitting display displays an image using organic light emitting diodes (OLEDs) that generate light by re-combination of electrons and holes. The organic light emitting display has high response speed and low power consumption.

The organic light emitting display includes pixels positioned at crossing regions between data lines and scan lines, a data driver for supplying data signals to the data lines, and a scan driver for supplying scan signals to the scan lines.

The scan driver sequentially supplies the scan signals to the scan lines. The data driver supplies the data signals to the data lines in synchronization with the scan signals.

When the scan signals are supplied to the scan lines, the pixels are selected to receive the data signals from the data lines. A voltage corresponding to a voltage difference between the data signal and a first power source is stored in a storage capacitor of a pixel that receives a data signal. Then, the pixel supplies current corresponding to the voltage stored in the storage capacitor from the first power source to a second power source via the OLED to generate light with corresponding brightness (e.g., predetermined brightness).

The voltage of the first power source is set in consideration of the amount and efficiency of current supplied to the OLED. In this case, the voltage range of the data signals is determined by the first power source so that a desired voltage may be charged in the storage capacitor. That is, in the conventional art, the voltage range of the data signals is determined by the first power source so that it is difficult to secure the degree of design freedom.

### SUMMARY

Aspects of embodiments of the present invention are directed toward an organic light emitting display with increased flexibility in controlling the voltage range of data signals and a method of driving the same.

According to an embodiment of the present invention, there is provided an organic light emitting display, including a scan driver for driving scan lines and emission control lines, a data driver for supplying data signals to data lines, pixels positioned at crossing regions of the scan lines and the data lines, first power source lines coupled to a first power source, each of the first power source lines coupled to a corresponding column of the pixels, horizontal power source lines extending in parallel with the scan lines, each of the horizontal power source lines coupled to a corresponding row of the pixels, a second power source line coupled to a second power source different from the first power source, and first switching elements coupled between the horizontal power source lines and the second power source line. Each of the pixels is configured to store a voltage corresponding to the second power source and the data signal and control an amount of current that flows from the first power source to correspond to the stored voltage.

A corresponding one of the first switching elements may be configured to turned on in a period where the voltage is stored in a storage capacitor included in each of a corresponding row of the pixels and turn off in the other periods. The scan driver may be configured to sequentially supply scan signals to the scan lines, sequentially supply emission control signals to the emission control lines, and sequentially supply inverted emission control signals to the inverted emission control lines. An i^{th} emission control signal of the emission control signals supplied to an i^{th} (i is a natural number) emission control line of the emission control lines may overlap an i^{th} scan signal of the scan signals supplied to an i^{th} scan line of the scan lines. An i^{th} inverted emission control signal of the inverted emission control signals supplied to an i^{th} inverted emission control line of the inverted emission control lines may be an inverted signal of the i^{th} emission control signal supplied to the i^{th} emission control line. An i^{th} first switching element of the first switching elements coupled to an i^{th} (i is a natural number) horizontal power source line of the horizontal power source lines may be configured to turn on in a period when an i^{th} inverted emission control signal of the inverted emission control signals is supplied to an i^{th} inverted emission control line of the inverted emission control lines and turn off in the other periods.

Each of the pixels positioned in an i^{th} (i is a natural number) row may include an organic light emitting diode (OLED), a pixel circuit for controlling the amount of current supplied to the OLED, a first transistor coupled between an i^{th} horizontal power source line of the horizontal power source lines and a first node that is commonly coupled to the pixel circuit and one of the first power source lines, the first transistor being configured to turned off when an i^{th} emission control signal of the emission control signals is supplied to an i^{th} emission control line of the emission control lines, and a storage capacitor coupled between the pixel circuit and the i^{th} horizontal power source line. The first transistor may be configured to turn off in a period where the storage capacitor is charged and turned on in other periods. The pixel may further include a second transistor coupled between the first node and the pixel circuit, the second transistor being configured to turn off when the i^{th} emission control signal is supplied to the i^{th} emission control line.

According to an embodiment of the present invention, a method of driving an organic light emitting display is provided. The method includes storing a voltage corresponding to a voltage difference between a data signal and a second power source in a storage capacitor and controlling an amount of current flowing from a first power source via an organic light emitting diode (OLED) to correspond to a voltage stored in the storage capacitor.

While storing the voltage in the storage capacitor, one terminal of the storage capacitor is electrically coupled to the second power source. The one terminal of the storage capacitor may be electrically coupled to the first power source to control the amount of current. While storing the voltage in the storage capacitor, a driving transistor for controlling the amount of current supplied to the OLED may not be electrically coupled to the first power source.

In the organic light emitting display according to the embodiment of the present invention, a voltage is charged in the storage capacitor using the second power source regardless of the first power source for supplying current to the OLED so that the voltage range of the data signals may be freely set. For example, according to the present invention, the voltage range of the data signals may be set as a low voltage so that manufacturing cost may be reduced.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic diagram illustrating an organic light emitting display according to an embodiment of the present invention;

FIG. 2 is a circuit diagram illustrating a pixel according to a first embodiment of the present invention;

FIG. 3 is a waveform diagram illustrating a method of driving the pixel of FIG. 2;

FIG. 4 is a circuit diagram illustrating a pixel according to a second embodiment of the present invention;

FIG. 5 is a circuit diagram illustrating a pixel according to a third embodiment of the present invention;

FIG. 6 is a waveform diagram illustrating a method of driving the pixel of FIG. 5; and

FIG. 7 is a circuit diagram illustrating a pixel according to a fourth embodiment of the present invention.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or indirectly coupled to the second element via one or more third elements. Further, some of the elements that are not essential to the complete understanding of the invention are omitted for clarity. Also, like reference numerals refer to like elements throughout.

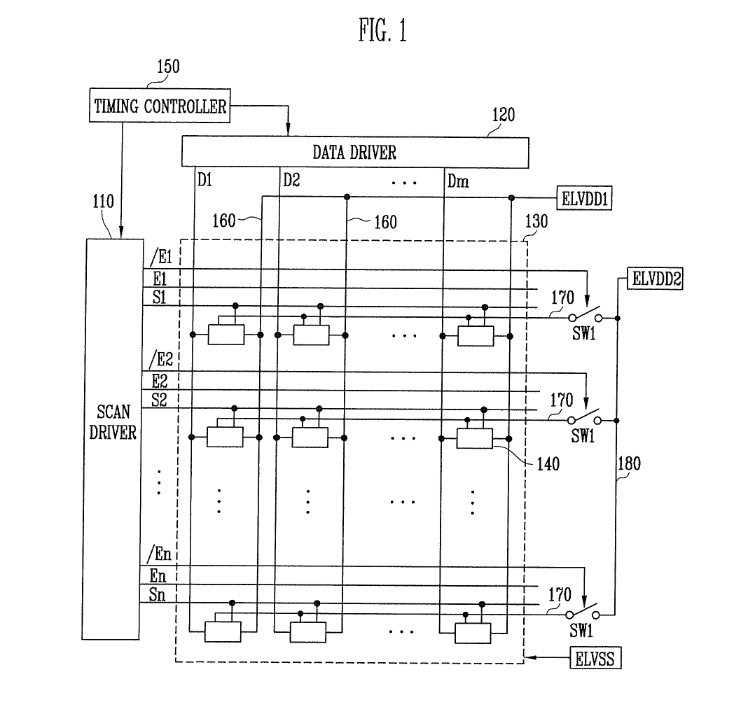

Hereinafter, exemplary embodiments of the present invention will be described in more detail with reference to FIGS. 1 to 7.

FIG. 1 is a schematic diagram illustrating an organic light emitting display according to an embodiment of the present invention.

Referring to FIG. 1, the organic light emitting display includes a display unit 130 having pixels 140 positioned at crossing regions of scan lines S1 to Sn and data lines D1 to Dm, a scan driver 110 for driving the scan lines S1 to Sn, emission control lines E1 to En, and inverted emission control lines /E1 to /En, a data driver 120 for driving the data lines D1 to Dm, and a timing controller 150 for controlling the scan driver 110 and the data driver 120.

In addition, the organic light emitting display of FIG. 1 includes first power source lines 160 extending in parallel with the data lines D1 to Dm as vertical lines to be coupled to the pixels 140, horizontal power source lines 170 extending in parallel with the scan lines S1 to Sn to be coupled to the pixels 140, a second power source line 180 formed outside the display unit 130 to be coupled to a second power source ELVDD2, and a first switching element SW1 formed between each of the horizontal power source lines 170 and the second power source line 180.

The scan driver 110 sequentially supplies scan signals to the scan lines S1 to Sn and sequentially supplies emission control signals to the emission control lines E1 to En. In addition, the scan driver 110 sequentially supplies inverted emission control signals to the inverted emission control lines /E1 to /En.

The scan signals may be set to have a first voltage (for example, a low level voltage) at which transistors included in the pixel 140 are turned on. The emission control signals may be set to have a second voltage (for example, a high level voltage) at which the transistors included in the pixel 140 are turned off. The inverted emission control signals may be obtained by inverting the polarities of the emission control signals using an inverter and may be set to have a third voltage at which the transistors are turned on.

In addition, according to one embodiment of the present invention, the widths (e.g., pulse widths) of the emission control signals and the scan signals may be set to suitably vary in accordance with the structure of the pixel 140. For example, the emission control signal supplied to the i^{th} (i is a natural number) emission control line Ei may overlap the scan signal supplied to the i^{th} scan line Si. The inverted emission control signal supplied to the i^{th} inverted emission control line /Ei may be generated by inverting the emission control signal supplied to the i^{th} emission control line Ei. Here, the inverted emission control signal supplied to the i^{th} inverted emission control line /Ei is different from the emission control signal supplied to the i^{th} emission control line Ei only in that the polarity of the inverted emission control signal supplied to the i^{th} inverted emission control line /Ei is inverted. In addition, the inverted emission control signal is supplied at the same point of time and has a same width (e.g., pulse width) as the emission control signal supplied to the i^{th} emission control line Ei.

The data driver 120 supplies data signals to the data lines D1 to Dm when the scan signals are supplied.

The timing controller 150 controls the scan driver 110 and the data driver 120. In addition, the timing controller 150 realigns data supplied from the outside and transmits the data to the data driver 120.

The first power source lines 160 are coupled to the pixels 140 in units of vertical lines (e.g., each of the first power source lines 160 is coupled to a corresponding column of the pixels 140). The first power source lines 160 are coupled to a first power source ELVDD1 for supplying the voltage of the first power source ELVDD1 to the pixels 140. The first power source ELVDD1 supplies current (e.g., predetermined current) to the OLEDs included in the pixels 140.

The second power source line 180 is formed outside the display unit 130 and is coupled to the second power source ELVDD2. The second power source ELVDD2 controls the voltage stored in the storage capacitor included in each of the pixels 140.

The horizontal power source lines 170 are coupled to the pixels 140 in units of horizontal lines (e.g., each of the horizontal power source lines 170 is coupled to a corresponding row of the pixels 140). The horizontal power source lines 170 supply the voltage of the second power source ELVDD2 to the pixels 140 when the first switching element SW1 is turned on.

The first switching element SW1 is formed between each of the horizontal power source lines 170 and the second power source line 180. When the inverted emission control signal is supplied, the first switching element SW1 is turned on to electrically couple the horizontal power source lines 170 to the second power source line 180.

The display unit 130 includes the pixels 140 positioned at the crossing regions between the scan lines S1 to Sn and the data lines D1 to Dm. A voltage corresponding to a voltage difference between the data signals and the second power source ELVDD2 is stored (or charged) in each of the pixels 140, and each of the pixels 140 controls the amount of current that flows from the first power source ELVDD1 to a third power source ELVSS via the OLED to correspond to the stored voltage.

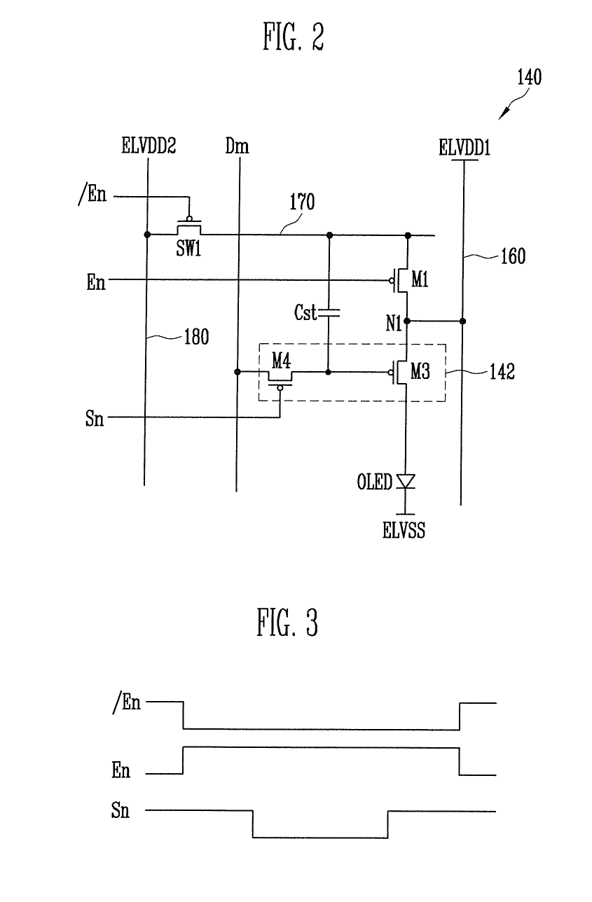

FIG. 2 is a circuit diagram illustrating a pixel according to a first embodiment of the present invention

Referring to FIG. 2, the pixel 140 includes an OLED, a pixel circuit 142 for controlling the amount of current supplied to the OLED, a first transistor M1 coupled between the pixel circuit 142 and a horizontal power source line 170, and a storage capacitor Cst.

The anode electrode of the OLED is coupled to the pixel circuit 142, and the cathode electrode of the OLED is coupled to the third power source ELVSS. The OLED generates light with a brightness corresponding to the current supplied from the pixel circuit 142.

The first electrode of the first transistor M1 is coupled to a first node N1 that is coupled to both a first power source line 160 and the pixel circuit 142, and the second electrode of the first transistor M1 is coupled to the horizontal power source line 170. The gate electrode of the first transistor M1 is coupled to the emission control line En. The first transistor M1 is turned off when an emission control signal (e.g., a high level voltage) is supplied to the emission control line En and is turned on in the other cases.

The storage capacitor Cst is coupled between the horizontal power source line 170 and the pixel circuit 142. The storage capacitor Cst stores a voltage corresponding to the data signal supplied from the pixel circuit 142 and the second power source ELVDD2 supplied from the horizontal power source line 170. More detailed description of the above will be provided below.

The pixel circuit 142 controls the amount of current that flows from the first power source ELVDD1 to the third power source ELVSS via the OLED to correspond to the voltage stored in the storage capacitor Cst. Here, the pixel circuit 142 includes a third transistor M3 and a fourth transistor M4.

The first electrode of the third transistor M3 (or a driving transistor) is coupled to the first node N1, and the second electrode of the third transistor M3 is coupled to the anode electrode of the OLED. The gate electrode of the third transistor M3 is coupled to one terminal of the storage capacitor Cst. The third transistor M3 controls the amount of current supplied to the OLED to correspond to the voltage stored in the storage capacitor Cst.

The first electrode of the fourth transistor M4 is coupled to the data line Dm, and the second electrode of the fourth transistor M4 is coupled to one terminal of the storage capacitor Cst. The gate electrode of the fourth transistor M4 is coupled to the scan line Sn. When a scan signal is supplied to the scan line Sn, the fourth transistor M4 is turned on to electrically couple the data line Dm to the one terminal of the storage capacitor Cst.

According to other embodiments of the present invention, the pixel circuit 142 may be realized by various suitable types of well-known circuits. That is, the pixel circuit 142 may be realized by various suitable types of circuits that may supply current to the OLED to correspond to the voltage stored in the storage capacitor Cst.

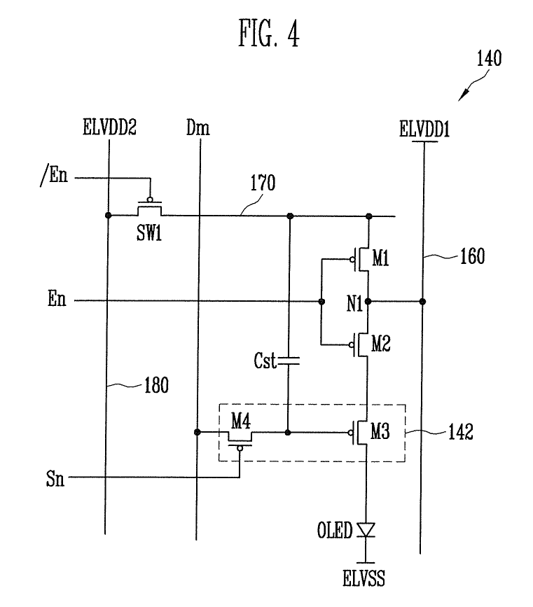

FIG. 3 is a waveform diagram illustrating a method of driving the pixel of FIG. 2.

Referring to FIG. 3, an emission control signal is supplied to the emission control line En, and the inverted emission control signal is supplied to the inverted emission control line /En.

When the emission control signal (e.g., a high level voltage) is supplied to the emission control line En, the first transistor M1 is turned off. When the inverted emission control signal (e.g., a low level voltage) is supplied to the inverted emission control line /En, the first switching element SW1 is turned on. When the first switching element SW1 is turned on, the second power source line 180 and the horizontal power source line 170 are electrically coupled to each other. In this case, the voltage of the second power source ELVDD2 is supplied to the horizontal power source line 170.

Then, a scan signal (e.g., a low level voltage) is supplied to the scan line Sn so that the fourth transistor M4 is turned on. When the fourth transistor M4 is turned on, a data signal from the data line Dm is supplied to one terminal of the storage capacitor Cst. At this time, the storage capacitor Cst stores the voltage corresponding to a voltage difference between the data signal and the second power source ELVDD2.

After the voltage is stored in the storage capacitor Cst, the supply of the scan signal to the scan line Sn is stopped so that the fourth transistor M4 is turned off. After the fourth transistor M4 is turned off, supply of the emission control signal to the emission control line En is stopped and supply of the inverted emission control signal to the inverted emission control line /En is stopped.

When the supply of the emission control signal to the inverted emission control line /En is stopped, the first switching element SW1 is turned off. When the supply of the emission control signal to the emission control line En is stopped, the first transistor M1 is turned on. When the first transistor M1 is turned on, the horizontal power source line 170 and the first power source line 160 are electrically coupled to each other so that the voltage of the first power source ELVDD1 is supplied to the horizontal power source line 170.

When the voltage of the first power source ELVDD1 is supplied to the horizontal power source line 170, since one terminal of the storage capacitor Cst is floated, the storage capacitor Cst maintains the voltage stored in a previous period regardless of the voltage of the first power source ELVDD1 supplied to the horizontal power source line 170. At this time, the third transistor M3 controls the amount of current that flows from the first power source ELVDD1 to the third power source ELVSS via the OLED to correspond to the voltage stored in the storage capacitor Cst.

According to the embodiment of FIG. 2, the voltage stored in the storage capacitor Cst is determined regardless of the voltage of the first power source ELVDD1 for supplying current to the OLED. That is, the voltage of a data signal is determined regardless of the voltage of the first power source ELVDD1 so that the voltage range of the data signals may be freely controlled.

For example, when the first power source ELVDD1 is set as 12V and the third power source ELVSS is set as 0V, in the conventional art, the data signals are set to have a voltage range between 7V and 13V. However, according to one embodiment of the present invention, the voltage of the second power source ELVDD2 is set as 4V so that the data signals may be set to have a voltage range between 0V and 5V. That is, according to embodiments of the present invention, the voltage range of the data signals may be freely controlled while controlling the voltage of the second power source ELVDD2. Therefore, the degree of design freedom may be improved. In addition, when the voltages of the data signals are reduced, the data driver 120 is driven at a lower voltage so that manufacturing cost may be reduced.

FIG. 4 is a circuit diagram illustrating another embodiment of the pixel 140 of FIG. 1. In FIG. 4, the same elements as FIG. 2 are denoted by the same reference numerals and detailed description thereof will be omitted.

Referring to FIG. 4, a pixel 140 according to the second embodiment of the present invention includes a second transistor M2 coupled between a first node N1 and the first electrode of a third transistor M3. The gate electrode of the second transistor M2 is coupled to the emission control line En. The second transistor M2 is turned off when the emission control signal (e.g., a high level voltage) is supplied to the emission control line En and is turned on in the other periods. That is, the second transistor M2 blocks (or prevents) electric coupling between the first node N1 and the first electrode of the third transistor M3 in a period where a voltage is stored in a storage capacitor Cst to prevent unnecessary current from flowing to the OLED.

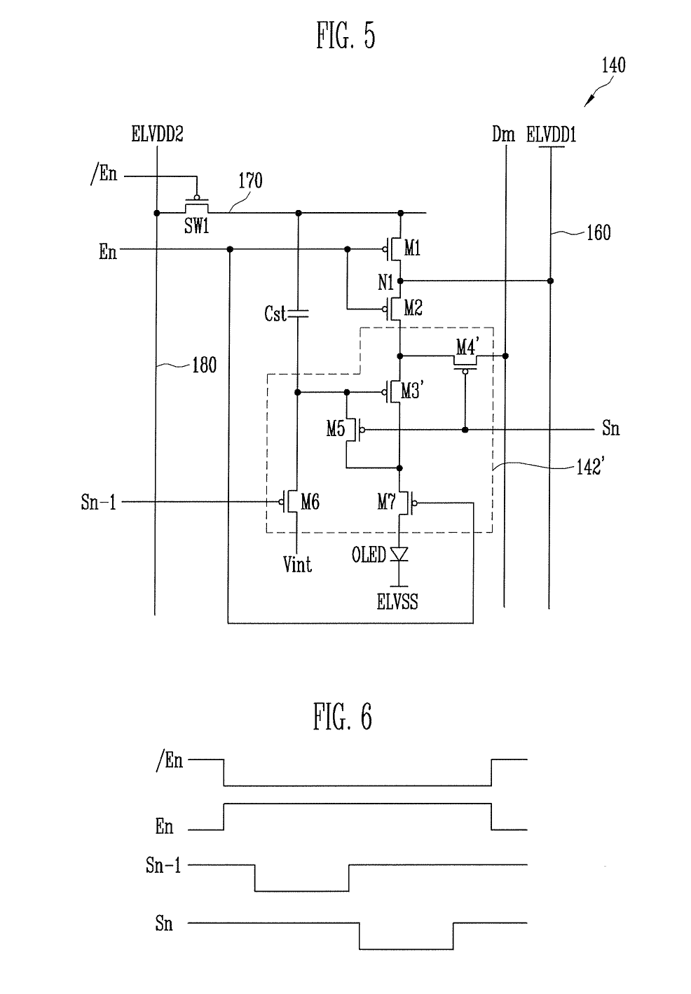

FIG. 5 is a circuit diagram illustrating a pixel according to a third embodiment of the present invention. In FIG. 5, the same elements as FIG. 4 are denoted by the same reference numerals and detailed description thereof will be omitted.

Referring to FIG. 5, a pixel circuit 142′ according to the third embodiment of the present invention includes five transistors M3′, M4′, M5, M6 and M7 in order to compensate for the threshold voltage of the third transistor M3′.

The first electrode of the third transistor M3′ is coupled to the second electrode of the second transistor M2, and the second electrode of the third transistor M3′ is coupled to the first electrode of the seventh transistor M7. Then, the gate electrode of the third transistor M3′ is coupled to one terminal of a storage capacitor Cst. The third transistor M3′ supplies current corresponding to the voltage stored in the storage capacitor Cst to the OLED.

The first electrode of a fourth transistor M4′ is coupled to the data line Dm, and the second electrode of the fourth transistor M4′ is coupled to the first electrode of the third transistor M3′. The gate electrode of the fourth transistor M4′ is coupled to the scan line Sn. When a scan signal (e.g., a low level voltage) is supplied to the scan line, the fourth transistor M4′ is turned on to electrically couple the data line Dm and the first electrode of the third transistor M3′ to each other.

The first electrode of the fifth transistor M5 is coupled to the second electrode of the third transistor M3′, and the second electrode of the fifth transistor M5 is coupled to the gate electrode of the third transistor M3′. The gate electrode of the fifth transistor M5 is coupled to the scan line Sn. The fifth transistor M5 is turned on when the scan signal is supplied to the scan line Sn so that the third transistor M3 is coupled in the form of a diode (e.g., diode-connected).

The first electrode of the sixth transistor M6 is coupled to one terminal of the storage capacitor Cst, and the second electrode of the sixth transistor M6 is coupled to an initialization power source Vint. The gate electrode of the sixth transistor M6 is coupled to the (n−1)^{th} scan line Sn−1. When a scan signal is supplied to the (n−1)^{th} scan line Sn−1, the sixth transistor M6 is turned on to supply the voltage of the initialization power source Vint to the one terminal of the storage capacitor Cst. The voltage of the initialization power source Vint is set to be lower than the voltage of a data signal.

The first electrode of the seventh transistor M7 is coupled to the second electrode of the third transistor M3′, and the second electrode of the seventh transistor M7 is coupled to the anode electrode of the OLED. The gate electrode of the seventh transistor M7 is coupled to the emission control line En. The seventh transistor M7 is turned off when an emission control signal (e.g., a high level voltage) is supplied to the emission control line En and is turned on in the other periods.

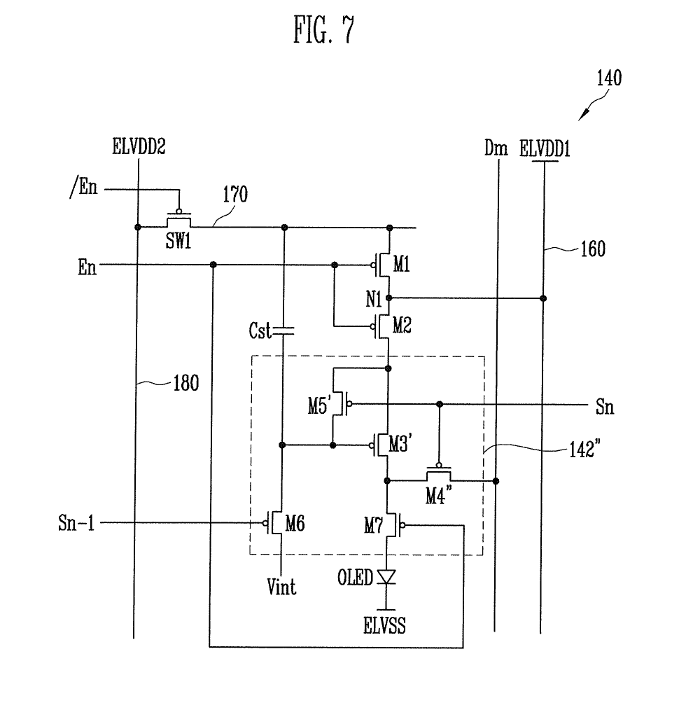

FIG. 6 is a waveform diagram illustrating a method of driving the pixel of FIG. 5.

Referring to FIG. 6, an emission control signal (e.g., a high level voltage) is supplied to the emission control line En, and an inverted emission control signal (e.g., a low level voltage) is supplied to the inverted emission control line /En. When the emission control signal is supplied to the emission control line En, the first transistor M1 and the second transistor M2 are turned off. When the inverted emission control signal is supplied to the inverted emission control line /En, the first switching element SW1 is turned on. When the first switching element SW1 is turned on, the second power source line 180 and the horizontal power source line 170 are electrically coupled to each other. In this case, the voltage of the second power source ELVDD2 is supplied to the horizontal power source line 170.

Then, the scan signal is supplied to the (n−1)^{th} scan line Sn−1 so that the sixth transistor M6 is turned on. When the sixth transistor M6 is turned on, the voltage of the initialization power source Vint is supplied to one terminal of the storage capacitor Cst and the gate electrode of the third transistor M3′ to be initialized.

After the initialization power source Vint is supplied to the one terminal of the storage capacitor Cst and the gate electrode of the third transistor M3′, the scan signal is supplied to the n^{th} scan line Sn so that the fourth transistor M4′ and the fifth transistor M5 are turned on. When the fourth transistor M4 is turned on, the data signal from the data line Dm is supplied to the first electrode of the third transistor M3′. At this time, since the gate electrode of the third transistor M3′ is initialized by the voltage of the initialization power source Vint, the data signal is supplied to the one terminal of the storage capacitor Cst via the third transistor M3′ coupled in the form of a diode. In this case, the storage capacitor Cst stores a voltage corresponding to a voltage difference between the voltage obtained by subtracting the absolute value threshold voltage of the third transistor M3′ from the voltage of the data signal and the second power source ELVDD2.

After the voltage is stored in the storage capacitor Cst, the supply of the scan signal to the scan line Sn is stopped so that the fourth transistor M4′ and the fifth transistor M5 are turned off. In addition, after the fourth transistor M4′ and the fifth transistor M5 are turned off, the supply of the emission control signal to the emission control line En is stopped and the supply of the inverted emission control signal to the inverted emission control line /En is stopped.

When the supply of the inverted emission control signal to the inverted emission control line /En is stopped, the first switching element SW1 is turned off. When the supply of the emission control signal to the emission control line En is stopped, the first transistor M1 and the second transistor M2 are turned on. When the first transistor M1 is turned on, the horizontal power source line 170 and the first power source line 160 are electrically coupled to each other. Therefore, the voltage of the first power source ELVDD1 is supplied to the horizontal power source line 170. When the second transistor M2 is turned on, the first electrode of the third transistor M3′ is electrically coupled to the first power source line 160.

When the voltage of the first power source ELVDD1 is supplied to the horizontal power source line 170, since one terminal of the storage capacitor Cst is floated, the storage capacitor Cst maintains the voltage stored in a previous period regardless of the voltage of the first power source ELVDD1 supplied to the horizontal power source line 170. At this time, the third transistor M3′ controls the amount of current that flows from the first power source ELVDD1 to the third power source ELVSS via the OLED to correspond to the voltage stored in the storage capacitor Cst.

FIG. 7 is a circuit diagram illustrating a pixel according to a fourth embodiment of the present invention. In FIG. 7, the same elements as FIG. 5 are denoted by the same reference numerals and detailed description thereof will be omitted.

Referring to FIG. 7, in a pixel circuit 142″ according to the fourth embodiment of the present invention, a fourth transistor M4″ is coupled between the second electrode of the third transistor M3′ and the data line Dm and is turned on when the scan signal is supplied to the n^{th} scan line Sn. The fourth transistor M4″ is turned on when the scan signal is supplied to the scan line Sn to electrically couple the second electrode of the third transistor M3′ and the data line Dm.

A fifth transistor M5′ is coupled between the first electrode of the third transistor M3′ and the gate electrode of the third transistor M3′. The fifth transistor M5′ is turned on when the scan signal is supplied to the scan line Sn to couple the third transistor M3′ in the form of a diode.

A method of driving the pixel 140 according to the fourth embodiment of the present invention is different from a method of driving the pixel according to the third embodiment of the present invention of FIG. 5 only in that the positions of the fourth transistor M4″ and the fifth transistor M5′ change. Therefore, detailed operation processes of the pixel 140 according to the fourth embodiment of the present invention will be omitted.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a scan driver for driving scan lines and emission control lines;
a data driver for supplying data signals to data lines;
pixels positioned at crossing regions of the scan lines and the data lines;
first power source lines coupled to a first power source, each of the first power source lines coupled to a corresponding column of the pixels;
horizontal power source lines extending in parallel with the scan lines, each of the horizontal power source lines coupled to a corresponding row of the pixels;
a second power source line coupled to a second power source different from the first power source; and
first switching elements coupled between the horizontal power source lines and the second power source line,
wherein each of the pixels is configured to store a voltage corresponding to the second power source and the data signal, and control an amount of current that flows from the first power source to correspond to the stored voltage.

2. The organic light emitting display as claimed in claim 1, wherein a corresponding one of the first switching elements is configured to turn on in a period where the voltage is stored in a storage capacitor included in each of a corresponding row of the pixels and turn off in other periods.

3. The organic light emitting display as claimed in claim 1, wherein the scan driver is configured to sequentially supply scan signals to the scan lines, sequentially supply emission control signals to the emission control lines, and sequentially supply inverted emission control signals to the inverted emission control lines.

4. The organic light emitting display as claimed in claim 3, wherein an i^{th} emission control signal of the emission control signals supplied to an i^{th} emission control line of the emission control lines overlaps an i^{th} scan signal of the scan signals supplied to an i^{th} scan line of the scan lines.

5. The organic light emitting display as claimed in claim 4, wherein an i^{th} inverted emission control signal of the inverted emission control signals supplied to an i^{th} inverted emission control line of the inverted emission control lines is an inverted signal of the i^{th} emission control signal supplied to the i^{th} emission control line.

6. The organic light emitting display as claimed in claim 3, wherein an i^{th} first switching element of the first switching elements coupled to an i^{th} horizontal power source line of the horizontal power source lines is configured to turn on in a period when an i^{th} inverted emission control signal of the inverted emission control signals is supplied to an i^{th} inverted emission control line of the inverted emission control lines and turn off in other periods.

7. The organic light emitting display as claimed in claim 3, wherein each of the pixels positioned in an i^{th} row comprises:
an organic light emitting diode (OLED);
a pixel circuit for controlling the amount of current supplied to the OLED;
a first transistor coupled between an i^{th} horizontal power source line of the horizontal power source lines and a first node that is commonly coupled to the pixel circuit and one of the first power source lines, the first transistor being configured to turn off when an i^{th} emission control signal of the emission control signals is supplied to an i^{th} emission control line of the emission control lines; and
a storage capacitor coupled between the pixel circuit and the i^{th} horizontal power source line.

8. The organic light emitting display as claimed in claim 7, wherein the first transistor is configured to turn off in a period where the storage capacitor is charged and turn on in other periods.

9. The organic light emitting display as claimed in claim 7, wherein the pixel further comprises a second transistor coupled between the first node and the pixel circuit, the second transistor being configured to turn off when the i^{th} emission control signal is supplied to the i^{th} emission control line.

10. The organic light emitting display as claimed in claim 7, wherein the pixel circuit comprises:
a third transistor coupled between the first node and the OLED and having a gate electrode coupled to one terminal of the storage capacitor; and
a fourth transistor coupled between one of the data lines and the one terminal of the storage capacitor, and being configured to turn on when an i^{th} scan signal of the scan signals is supplied to an i^{th} scan line of the scan lines.

11. The organic light emitting display as claimed in claim 9, wherein the pixel circuit comprises:
a third transistor coupled between the second transistor and the OLED, and having a gate electrode coupled to one terminal of the storage capacitor;
a fourth transistor coupled between a first electrode of the third transistor and the data line, and being configured to turn on when an i^{th} scan signal of the scan signals is supplied to an i^{th} scan line of the scan lines;
a fifth transistor coupled between a second electrode of the third transistor and a gate electrode of the third transistor, and being configured to turn on when the i^{th} scan signal is supplied to the i^{th} scan line;
a sixth transistor coupled between the one terminal of the storage capacitor and an initialization power source, and being configured to turn on when an (i−1)^{th} scan signal of the scan signals is supplied to an (i−1)^{th} scan line of the scan lines; and
a seventh transistor coupled between a second electrode of the third transistor and the OLED, and being configured to turn off when an i^{th} emission control signal of the emission control signals is supplied to the i^{th} emission control line.

12. The organic light emitting display as claimed in claim 7, wherein the pixel circuit comprises:
a third transistor coupled between the second transistor and the OLED, and having a gate electrode coupled to one terminal of the storage capacitor;
a fourth transistor coupled between a second electrode of the third transistor and one of the data lines, and being configured to turn on when an i^{th} scan signal of the scan signals is supplied to an i^{th} scan line of the scan lines;
a fifth transistor coupled between a first electrode of the third transistor and a gate electrode of the third transistor, and being configured to turn on when the i^{th} scan signal is supplied to the i^{th} scan line;
a sixth transistor coupled between the one terminal of the storage capacitor and an initialization power source, and being configured to turn on when an (i−1)^{th} scan signal of the scan signals is supplied to an (i−1)^{th} scan line of the scan lines; and
a seventh transistor coupled between the second electrode of the third transistor and the OLED, and being configured to turn off when an i^{th} emission control signal of the emission control signals is supplied to the i^{th} emission control line.

13. A method of driving an organic light emitting display, the method comprising:
storing a voltage corresponding to a voltage difference between a data signal and a second power source in a storage capacitor; and
controlling an amount of current flowing from a first power source via an organic light emitting diode (OLED) to correspond to a voltage stored in the storage capacitor.

14. The method as claimed in claim 13, wherein, while storing the voltage in the storage capacitor, one terminal of the storage capacitor is electrically coupled to the second power source.

15. The method as claimed in claim 14, wherein the one terminal of the storage capacitor is electrically coupled to the first power source to control the amount of current.

16. The method as claimed in claim 13, wherein, while storing the voltage in the storage capacitor, a driving transistor for controlling the amount of current supplied to the OLED is not electrically coupled to the first power source.
